(19) United States
(12) Patent Application Publication
(10) Pub. No.: US 2014/0214535 A1
(43) Pub. Date: Jul. 31, 2014

(54) CONTENT SEQUENCING

(71) Applicant: Google Inc., Mountain View, CA (US)

(72) Inventors: William P. Kee, San Francisco, CA (US); Chao Cai, San Jose, CA (US)

(73) Assignee: Google Inc., Mountain View, CA (US)

(21) Appl. No.: 13/754,551

(22) Filed: Jan. 30, 2013

(51) Int. Cl. G06Q 30/02

(52) U.S. Cl. CPC G06Q 30/0273
USPC 705/14.53

(57) ABSTRACT

This specification describes technologies relating to selection and display of content items based in part on sequencing information. In general, one aspect of the subject matter described in this specification can be embodied in methods that include receiving a request for content and a user identifier. The methods may further include identifying a sequence of content items in a browsing history corresponding to the user identifier, where the content items in the sequence are members of a set of content items. The methods may further include retrieving an estimate of a conditional probability of conversion for a first content item from the set, where the first content item is presented after the identified sequence. The methods may further include determining a bid for an impression in the requested content based in part on the estimate of the conditional probability of conversion and transmitting the bid.

### TECHNICAL FIELD

This disclosure relates to the selection and display of online content.

### BACKGROUND

The Internet provides access to a wide variety of resources. For example, video and/or audio files, as well as web pages for particular subjects or particular news articles, are accessible over the Internet. Access to these resources presents opportunities for content (e.g., advertisements) to be provided with the resources. The pairing of content with requested resources can generate value. For example, a web page can include content slots in which advertisements or other content can be presented. These content slots can be defined in the web page or defined for presentation with a web page, for example, in a pop-up window.

### SUMMARY

This specification describes technologies relating to facilitating the presentation of content items to users in preferred sequences. In general, one aspect of the subject matter described in this specification can be embodied in a method that includes receiving a request for content and a user identifier. The method may further include identifying a sequence of content items in a browsing history corresponding to the user identifier, where the content items in the sequence are members of a set of content items. The method may further include retrieving an estimate of a conditional probability of conversion for a first content item from the set, where the first content item is presented after the identified sequence. The method may further include determining a bid for an impression in the requested content based in part on the estimate of the conditional probability of conversion. The method may further include transmitting the bid.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including receiving a request for content and a user identifier. The operations may further include identifying a sequence of content items in a browsing history corresponding to the user identifier, where the content items in the sequence are members of a set of content items. The operations may further include retrieving an estimate of a conditional probability of conversion for a first content item from the set, where the first content item is presented after the identified sequence. The operations may further include determining a bid for an impression in the requested content based in part on the estimate of the conditional probability of conversion. The operations may further include transmitting the bid.

In general, one aspect of the subject matter described in this specification can be embodied in a system that includes a network interface configured to receive a request for content and a user identifier. The system may include a means for identifying a sequence of content items in a browsing history corresponding to the user identifier, where the content items in the sequence are members of a set of content items. The system may include a module configured to retrieve an estimate of a conditional probability of conversion for a first content item from the set, where the first content item is presented after the identified sequence. The system may include a module configured to determine a bid for an impression in the requested content based in part on the estimate of the conditional probability of conversion. The system may include a network interface configured to transmit the bid.

In general, one aspect of the subject matter described in this specification can be embodied in a non-transient computer readable media storing software including instructions executable by a processing device that upon such execution cause the processing device to perform operations that include receiving a request for content and a user identifier. The operations may further include identifying a sequence of content items in a browsing history corresponding to the user identifier, where the content items in the sequence are members of a set of content items. The operations may further include retrieving an estimate of a conditional probability of conversion for a first content item from the set, where the first content item is presented after the identified sequence. The operations may further include determining a bid for an impression in the requested content based in part on the estimate of the conditional probability of conversion. The operations may further include transmitting the bid.

In general, one aspect of the subject matter described in this specification can be embodied in a method that includes receiving a request for content and a user identifier. The method may further include identifying a sequence of content items in a browsing history corresponding to the user identifier, where the content items in the sequence are members of a set of content items. The method may further include retrieving an estimate of a conditional probability of conversion for a first content item from the set, where the first content item is presented after the identified sequence. The method may further include determining an allocation score for the first content item based in part on the estimate of the conditional probability of conversion. The method may further include selecting the first content item for presentation to user based on the allocation score. The method may further include transmitting data specifying the first content item in response to the request for content.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including receiving a request for content and a user identifier. The operations may further include identifying a sequence of content items in a browsing history corresponding to the user identifier, where the content items in the sequence are members of a set of content items. The operations may further include retrieving an estimate of a conditional probability of conversion for a first content item from the set, where the first content item is presented after the identified sequence. The operations may further include determining an allocation score for the first content item based in part on the estimate of the conditional probability of conversion. The operations may further include selecting the first content item for presentation to user based on the allocation score. The operations may further include transmitting data specifying the first content item in response to the request for content.

In general, one aspect of the subject matter described in this specification can be embodied in a system that includes a network interface configured to receive a request for content and a user identifier. The system may include a means for identifying a sequence of content items in a browsing history corresponding to the user identifier, where the content items in the sequence are members of a set of content items. The system may include a module configured to retrieving an estimate of a conditional probability of conversion for a first content item from the set, where the first content item is presented after the identified sequence. The system may include a module configured to determine an allocation score for the first content item based in part on the estimate of the conditional probability of conversion. The system may include a module configured to select the first content item for presentation to user based on the allocation score. The system may include a network interface configured to transmit data specifying the first content item in response to the request for content.

In general, one aspect of the subject matter described in this specification can be embodied in a non-transient computer readable media storing software including instructions executable by a processing device that upon such execution cause the processing device to perform operations that include receiving a request for content and a user identifier. The operations may further include identifying a sequence of content items in a browsing history corresponding to the user identifier, where the content items in the sequence are members of a set of content items. The operations may further include retrieving an estimate of a conditional probability of conversion for a first content item from the set, where the first content item is presented after the identified sequence. The operations may further include determining an allocation score for the first content item based in part on the estimate of the conditional probability of conversion. The operations may further include selecting the first content item for presentation to user based on the allocation score. The operations may further include transmitting data specifying the first content item in response to the request for content.

These and other embodiments can each optionally include one or more of the following features. Data specifying the first content item may be transmitted in response to the request for content. Data reflecting a conversion resulting from presentation of the first content item may be received. Data reflecting the conversion may be stored in a record associated with a sequence consisting of the identified sequence followed by the first content item. Identifying the sequence of content items may include determining time intervals between content items in a detected sequence of content items. Identifying the sequence of content items may include classifying a content item in the sequence of content items as a member of a subset of the set of content items. The set of content items may be advertisements of an advertiser and the subset may include advertisements in a particular advertising campaign. Identifying the sequence of content items may include classifying the sequence of content items as a member of a set of sequences that are each associated with the same one or more estimates of conditional probability of conversion. The set of sequences may include permutations of the content items in the sequence. The estimate of the conditional probability of conversion may be an estimate of the probability that a user will make a purchase associated with the first content item being present after the identified sequence.

Particular embodiments of the subject matter described in this disclosure can be implemented to realize none, one or more of the following advantages. Some implementations may facilitate the presentation of content items at the right time to complete an effective sequence of related presentations. Some implementations may increase the average conversion rates for a set of advertisements. Some implementations may facilitate efficient allocation of impressions.

The details of one or more embodiments of the subject matter described in this disclosure are set forth in the accompanying drawings and the description below. Other features, aspects, and advantages of the invention will become apparent from the description, the drawings, and the claims.

### BRIEF DESCRIPTION OF THE DRAWINGS

FIG. 1 is a block diagram of an example online environment.

FIGS. 2A-2B are flow charts of example processes for selecting content items for presentation based in part on sequence information.

FIG. 3 is a flow chart of an example process for detecting sequences of content items in a browsing history for a user.

FIG. 4 is a flow chart of an example process for estimating sequence conversion probabilities.

FIG. 5 shows an example of a computer device and a mobile computer device that can be used to implement the techniques described here.

### DETAILED DESCRIPTION

Pairing of relevant content items (e.g., advertisements) with online resources can provide benefits to all parties, including users, advertisers, and resource publishers. One reason to present content items is to encourage conversions (e.g., user purchases associated with the presentation of a content item). The probability of conversion resulting from the presentation of a single content item, without regard to the user's history of past content item interactions, may be estimated, for example, by counting the number of conversions resulting from a large number of past impressions for the content item for a group of users and dividing this conversion count by the total number of such impressions. The content item may then be selected for presentation in future impressions based in part on this estimate of the conversion probability.

However, the presentation of related content items to a user in a sequence may affect a user's perception of those content items and impact the conversion probability for each of the content items in the sequence. Thus, the conditional probability of conversion for a content item, given the sequence of content items that have been presented to the user in the recent past, may be different than the overall probability of conversion for the content item, e.g., absent knowledge of past related impressions. For example, a set of related content items, {Ad1, Ad2, Ad3, Ad4}, may include advertisements that are part of an advertiser's advertising campaign. Each of the advertisements may have an overall conversion probability of about 0.7%. Analysis may show that exposure to the related advertisements in the following sequence increases the probability of conversion for a set of users:
Ad1 (0.5% probability)->Ad2 (0.8% probability)->Ad3 (1.5% probability)->Ad4 (5% probability)
   By recognizing that a user requesting content including an impression has been exposed to Ads 1-3, but had not yet been exposed to Ad4, an advertisement management system may use this information to select Ad4 for presentation and/or generate a bid for the impression in a real-time auction. For example, an advertiser may normally bid a low amount to show Ad4 to a user with no known history of viewing related content items, but when a bid for an impression with a user with previous exposure to the sequence of Ads 1-3 becomes available, the advertiser could increase the bid significantly, making it more likely that Ad4 will be shown to the right user at the right time. In some cases, presentations of a sequence of related content items may result in a conditional probability of conversion that is lower than the overall probability of conversion for a next content item in the sequence. For example, users may be saturated with information about a topic of the content items in a set and may be annoyed by additional presentations of content items in the set.

In some implementations, data reflecting impressions and/or user interactions for a set of related content items (e.g., a set of advertisements from a particular advertiser) is extracted from of a large volume of user browsing histories (e.g., data for tens or hundreds or thousands, or millions of users) for analysis. In some implementations, multiple related sequences are grouped together for analysis and treated as one type of sequence. For example, all six permutations of successive impressions for Ads 1-3 may be grouped together for analysis, so that any sequence presenting each of these three advertisements is considered the same. In some implementations, each sequence is treated separately. User behavior, as reflected in various types of conversion data, corresponding to each sequence or group of sequences is analyzed to estimate a probability of conversion for the sequence or group of sequences. Various types of statistical regression can be applied to identify those sequences of content item presentations and/or interactions that are associated with increased probability of conversion. The sequence conversion probabilities may be stored or transmitted for use in future impression allocation decisions.

When a request for content associated with a user is received, a browsing history for the user is analyzed to identify one or more sequences that the user has been exposed to during a recent period of time (e.g., the last week or month). One or more candidate content items are considered for allocation of the impression. The conditional probability of conversion is determined for a candidate content item by retrieving the conversion probability for a sequence that includes an identified sequence form the user's history and the candidate content item served as the next content item in the sequence. A bid for the impression or an allocation score may be determined based in part on the conditional probability of conversion for the candidate content item. A high bid or allocation score increases the chances that the impression will be allocated to the content item. If the bid is accepted or the allocation score is the highest available, the candidate content item is selected for presentation to the user in the current impression. When the content item is selected, data specifying the content item may be transmitted to facilitate the presentation of the content item to a user in the impression.

A conversion occurs when a user performs a particular action related to a content item (e.g., an advertisement) provided with a resource or search results page. What constitutes a conversion may vary from case to case and can be determined in a variety of ways. For example, a conversion may occur when a user clicks on an advertisement, is referred to a web page, and consummates a purchase there before leaving that web page. A conversion can also be defined by an advertiser to be any measurable/observable user action such as, for example, downloading a white paper, navigating to at least a given depth of a website, viewing at least a certain number of web pages, spending at least a predetermined amount of time on a website or web page, registering on a website, etc. Other actions that constitute a conversion can also be used.

A click through rate for a content item (e.g., an advertisement) may be defined as the number of user clicks on the content item divided by the number of impressions (e.g., presentations to users) that the content item has been allocated. An aggregate click through rate for multiple content items may be the sum of all clicks on qualified content items divided by the total numbers of impressions allocated to all qualified content items.

A predicted click through rate for a content item may be an estimate of the future click through rates for a content item and may be based in part on data reflecting past user interactions with the content item or similar content items in similar impressions. For example, a predicted click through rate may be generated using a machine learning system to process data reflecting past user interactions, among other information, and estimate or predict future click through rates.

A content item is any data that can be provided over an electronic communications network to cause a visual and/or auditory presentation on a user device. For example, an advertisement, including a link to a landing page is a content item. In some implementations a content item may include the presentable content itself (e.g., a picture, a video, or an audio file). In some implementations a content item may include instructions or other information (e.g., a pointer) that causes presentable content to be loaded or retrieved (e.g., from a remote server). The processes described below are illustratively applied to content items that are advertisements provided in response to a request from an online resource, but the processes are also applicable to other content items provided over a network.

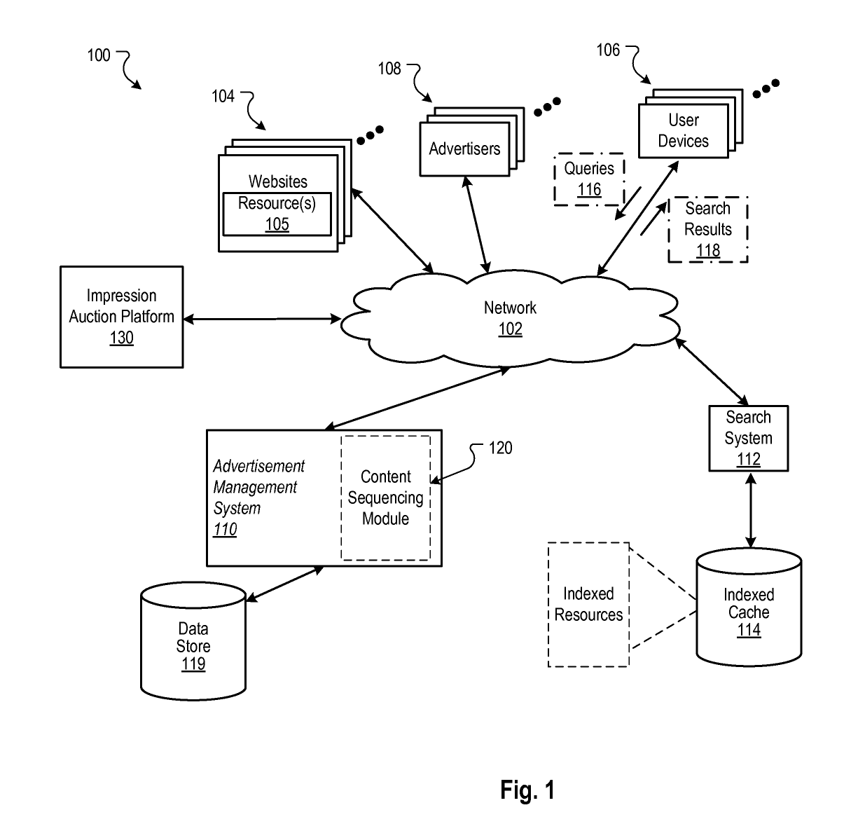

FIG. 1 is a block diagram of an example online environment 100 in which a content management system (e.g. advertisement management system 110) manages content delivery services. The example environment 100 includes a network 102, e.g., a local area network (LAN), wide area network (WAN), the Internet, or a combination thereof. The network 102 connects websites 104, user devices 106, content providers (e.g., advertisers 108), and the advertisement management system 110. The example environment 100 may include many thousands of websites 104, user devices 106, and advertisers 108.

A website 104 includes one or more resources 105 associated with a domain name and hosted by one or more servers. An example website is a collection of webpages formatted in hypertext markup language (HTML) that can contain text, images, multimedia content, and programming elements, e.g., scripts. Each website 104 is maintained by a publisher, e.g., an entity that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few examples. The resources can include content, e.g., words, phrases, images and sounds that may include embedded information (e.g., meta-information in hyperlinks) and/or embedded instructions (e.g., JavaScript scripts).

A user device 106 is an electronic device that is under control of a user and is capable of requesting and receiving resources over the network 102. Example user devices 106 include personal computers, mobile communication devices, and other devices that can send and receive data over the network 102. A user device 106 typically includes a user application (e.g., a web browser) to facilitate the sending and receiving of data over the network 102 and the presentation of content to a user.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which advertisements or other content can be presented. These specified portions of the resource or user display are referred to as advertisement slots or content slots. A presentation of a content item in a content slot may be referred to as an impression. Selection of a content item for presentation in response to a resource request may be interchangeably referred to as allocation of an impression to the selected content item (e.g., an advertisement).

To facilitate searching of these resources, the environment can include a search system 112 that identifies the resources by crawling and indexing the resources provided by the publishers on the websites 104. Data about the resources can be indexed based on the resource to which the data corresponds. The indexed and, optionally, cached copies of the resources are stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the uniform resource locator (URL) of the web page. Search results pages can also include one or more advertisement slots in which advertisements or other content can be presented.

When a resource 105 or search results 118 are requested by a user device 106, the advertisement management system 110 receives a request for additional content (e.g., advertisements) to be provided with the resource 105 or search results 118. The request for advertisements can include characteristics of the advertisement slots that are defined for the requested resource or search results page, and these requests are provided to the advertisement management system 110.

For example, a reference (e.g., URL) to the resource for which the advertisement slot is defined, a size of the advertisement slot, and/or media types that are available for presentation in the advertisement slot can be provided to the advertisement management system 110. Similarly, keywords associated with a requested resource (“resource keywords”) or a search query 116 for which search results are requested can also be provided to the advertisement management system 110 to facilitate identification of advertisements that are relevant to the resource or search query 116.

Based on data included in the request for advertisements, the advertisement management system 110 can select advertisements that are eligible to be provided in response to the request (“eligible advertisements”). For example, eligible advertisements can include advertisements having characteristics matching the characteristics of advertisement slots and that are identified as relevant to specified resource keywords or search queries 116.

In some implementations, the advertisement management system 110 can select from the eligible advertisements that are provided for presentation in advertisement slots of a resource or search results page based on results of an auction. For example, the advertisement management system 110 can receive bids from advertisers and allocate the advertisement slots to the highest bidders at the conclusion of the auction. The bids are amounts that the advertisers are willing to pay for presentation (or selection) of their advertisement with a resource or search results page. For example, a bid can specify an amount that an advertiser is willing to pay for each 1000 impressions (e.g., presentations) of the advertisement, referred to as a cost-per-mille (CPM) bid. Alternatively, the bid can specify an amount that the advertiser is willing to pay for a selection (e.g., a click-through) of the advertisement or a conversion following selection of the advertisement. The highest bidders can be determined based on the bids alone, or based on the bids of each bidder being multiplied by one or more factors (e.g., quality scores derived from advertisement performance, landing page scores, and the like).

The advertisement management system may store and access data regarding past allocations of content items and user interactions in a data store 119. The data store 119 is a data store that stores data representing previous user interactions with publisher websites and advertisements. For example, in response to receiving a request for an advertisement, the advertisement management system 110 can store data identifying the website to which the request corresponds and identifying the request as an impression for the website. Additionally, the advertisement management system 110 can store data representing the advertisements that were provided in response to the request and any user actions (e.g., click-throughs, purchases, or other conversions) that are detected following presentation of the advertisements. The data store 119 may also store user session logs.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, zone improvement plan (ZIP) code, or state level), so that a particular location of a user cannot be determined. Thus, users may have control over how information is collected about them and used by a content server.

In some implementations, the data store 119 may also store data organized into records for sequences of related content items. For example, records may be maintained for sequences of advertisements from a particular advertiser's advertising campaign (e.g., a set of advertisements promoting a new mobile phone). When presentation of the last content item in a sequence is completed data received reporting whether a conversion event occurring in response to the last impression may be record in a record for the sequence. These records may be used to determine estimates of the probability of conversion for the sequence.

In some implementations, estimates of the probabilities of conversion for sequences of content items in the set of related content items are stored in tree structures, where child nodes correspond to sequences matching the sequence(s) for the parent node with the one additional content item presented as the next content item in the sequence. For example, in the case of unique strictly ordered sequences (as opposed to, e.g., groups of permutations), the sequence for a parent node is a prefix for the sequence(s) corresponding to its child node(s). Given a sequence of past content item impressions, this structure may be accessed to find the node corresponding to past sequence and find estimates of conditional probabilities of conversion for possible next content items in the corresponding child nodes.

The advertisement management system 110 may also include a content sequencing module 120. The content sequencing module 120 may receive data describing a set of related content items from a content provider (e.g., one of the advertisers 108) through a server system interface component of the advertisement management system 110. This data may be stored in the data store 119. The content sequencing module 120 may further analyze a large number of user session logs to detect sequences of presentations of content items from the set of related content items. These sequence occurrences may be correlated with conversion data from the user session logs or some other data source and an evaluation may be made as to whether or not each occurrence of a sequence resulted in a conversion. The data for a sequence may be aggregated across many users and used to determine an estimate of the probability of conversion for the sequence. In some implementations, the determined estimates of probabilities of conversion may be stored in data store 119 in a records associated with a sequences of related content items.

When the advertisement management system 110 receives a request for content including an impression associated with a particular user, the content sequencing module 120 may analyze a browsing history for the user associated with the request to identify any sequence of content items from the set of related content items in the user's browsing history. An estimate of a conditional probability of conversion may be retrieved for an eligible content item from the set of related content items. For example, the estimate of the conditional probability of conversion may be retrieved from a record in the data store 119.

In some implementations, the estimate of the conditional probability of conversion for an eligible/candidate content item is used to determine a bid for allocation of the impression to the candidate content item. For example, the bid may be transmitted to impression auction platform 130, which runs an auction and allocates the impression in the requested content to the highest bidder. If the bid for the candidate content item is the highest/winning bid, then the impression is allocated to the content item and the content item may be presented as the next content item in the sequence presented to the user.

In some implementations, a determined estimate of the conditional probabilities of conversion for one or more eligible content items from the set of related content items may be used to determine, in part, allocation scores for the candidate content items. The allocation scores may in turn be used by the advertisement management system 110 to allocate impressions to a content item in a sequence of related content items.

Allocation of the impression to the content item may result in a transmission of data specifying the content item in response to a user request for content. For example, the data specifying the content item may be transmitted through a server system interface component of the advertisement management system 110.

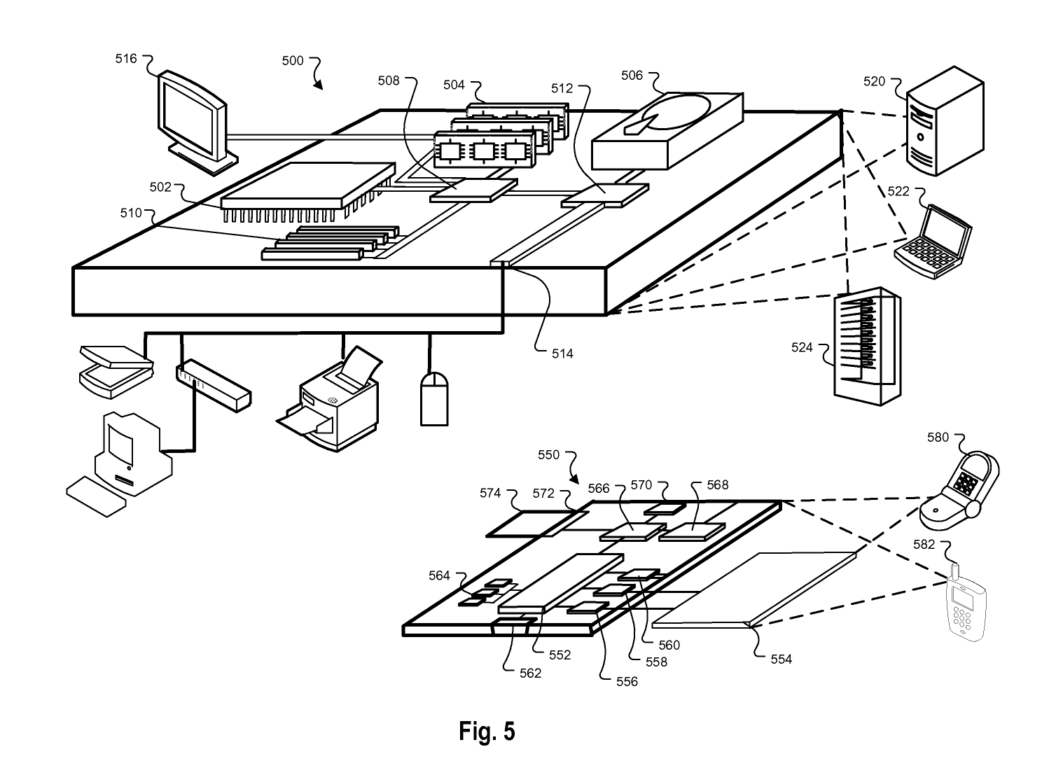

The advertising management system 110 may be implemented as software that is executed on one or more processing apparatus, e.g., a computer system described in FIG. 5.

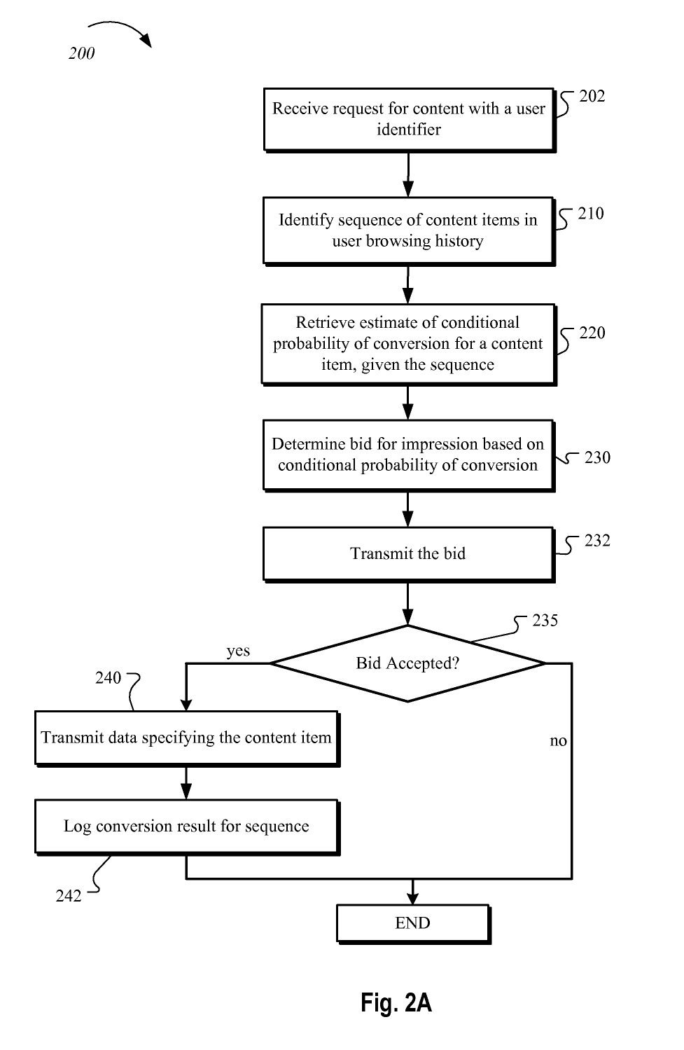

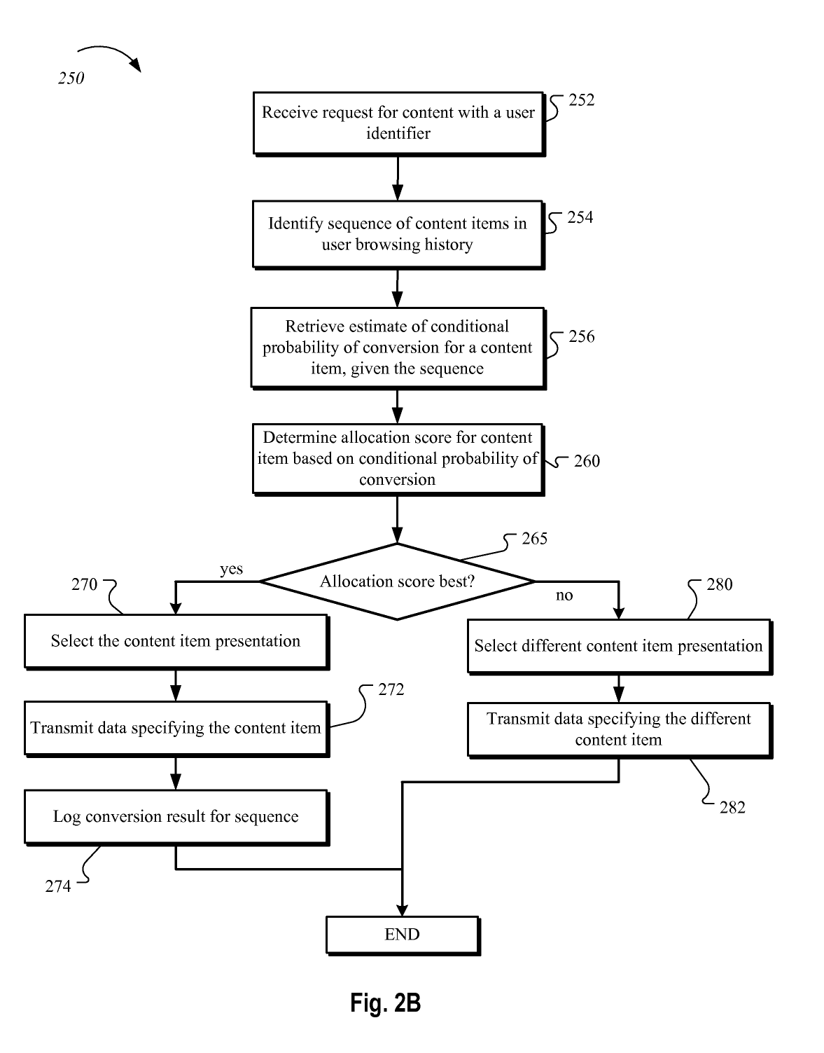

FIG. 2A is a flow chart of an example process 200 for selecting content items for presentation based in part on sequence information. The process 200 can be implemented, for example, by the content sequencing module 120 in the advertisement management system 110 of FIG. 1. In some implementations, the advertisement management system 110 is a data processing apparatus that includes one or more processors that are configured to perform actions of the process 200. For example, the data processing apparatus may be the apparatus 500 described in FIG. 5. In some implementations, a non-transitory computer readable storage medium can include instructions that when executed by a computing device (e.g., a computer system) cause the device to perform actions of the process 200.

According to process 200, a request for content is received 202, including a user identifier. For example, the user identifier may be included in a user authorized cookie that is associated with the request for content. With a user's permission, the user identifier may be used to access a browsing history for the associated user. For example, with appropriate permissions, a cookie may encode some of the corresponding user's browsing history. In some implementations, the user identifier points to, and may be used to access, a user session log or other data structure stored by a server system (e.g., advertisement management system 110 or another remote server) that encodes the user's browsing history. The request may also specify other parameters of a proposed impression (e.g., parameters of the content slot, terms from website or search terms from a query resulting in search results in which the content slot occurs). For example, the request may be received 202 through a network interface of the advertisement management system 110 from search system 112 or a website 104 that seeks to have a content item (e.g., an advertisement) presented to interested users in a current impression. In some implementations, the request may be received from impression auction platform 130 and may include data describing an auction for the impression (e.g., a reserve price). In some implementations, the request may be received, along with a cookie, directly from a user device 106.

One or more sequences of related content items are identified 210 in the browsing history for the user. In some implementations, analysis of the user's browsing history is limited to a recent window of time (e.g., the last day, week, month, etc.). The browsing history may be filtered to extract events (e.g., impressions) relating to content items in a set of related content items (e.g., content items for a particular advertiser or for a particular advertising campaign). These extracted events may have time stamps or an explicit or implicit temporal ordering. Once the raw sequence of content items of interest is extracted, the sequence may be mapped to one or more sequences or groups of sequences that are detected and analyzed by the content sequencing module 120. Sequences can be grouped for analysis purposes in a variety of ways. For example, the raw sequence may be mapped to group of sequences corresponding to permutations of the content items in the sequence. In some implementations, each ordered sequence is analyzed individually, so the raw sequence is the sequence of interest. In some implementations, ordered sequences are more finely classified for analysis purposes. For example, different instances of the same sequence of three content items (e.g., Ad1->Ad2->Ad3) may be classified into different analysis groups based on the time lags between impressions for the content items in the sequence. Where all three impressions occurred with 24 hours, the sequence may be in one analysis group, while sequences spread over a longer period may be in another analysis group. In some implementations, inter-impression time lags exceeding a threshold (e.g., a day or a week) cause the larger sequence to be ignored or bifurcated into shorter sequences before and after the gap. Thus, identifying 210 the sequence may include determining time intervals between content items in a detected sequence of content items.

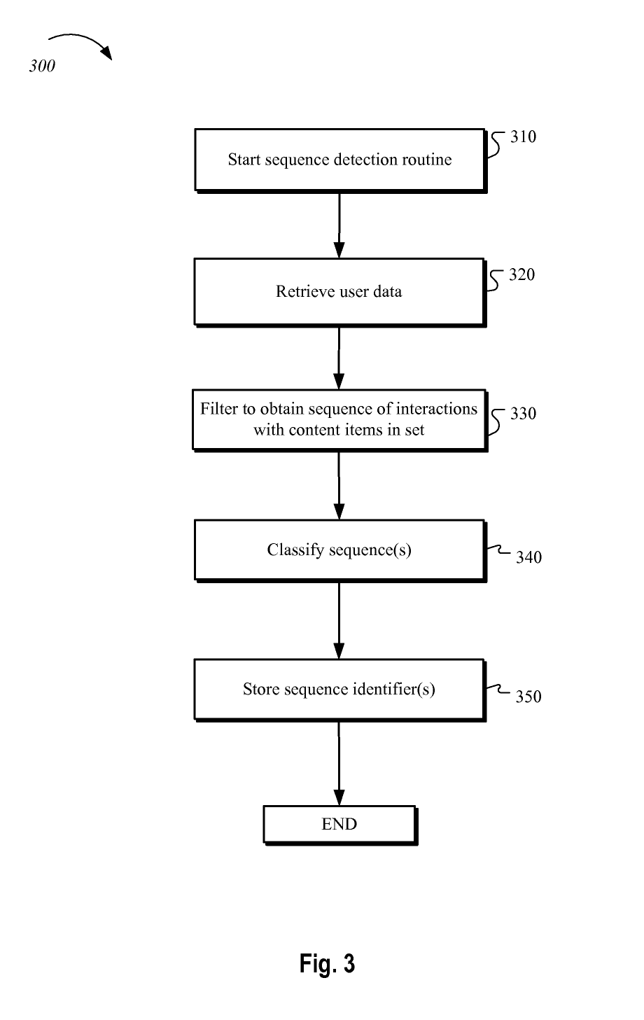

In some implementations, a sequence is identified 210 from the user's browsing history based on a real-time analysis of the browsing history. In some implementations, a sequence is identified 210 by retrieving a sequence identifier (e.g., a tag) associated with a sequence analysis group that has been previously determined based on the user's browsing history and stored in a record associated with the user that may be accessed using the user identifier. For example, process 300 of FIG. 3 may have been performed previously to identify sequences of interest in the user's browsing history.

For example, the sequence may be identified 210 by the content sequencing module 120 of the advertisement management system 110.

An estimate of the conditional probability of conversion is retrieved 220 for an eligible content item in the set of related content items. This eligible content item may be a candidate content item for allocation of an impression associated with the request for content. The estimate of the conditional probability of conversion for the content item may be determined as the estimate of the probability of conversion for an extended sequence including the identified sequence with the candidate content item appended to the end of the sequence. For example, this estimate of the conditional probability of conversion may be based on analysis of user session logs and/or other conversion data for many users who have been exposed to the extended sequence in a past window of time (e.g., the last week, month, year, etc.)

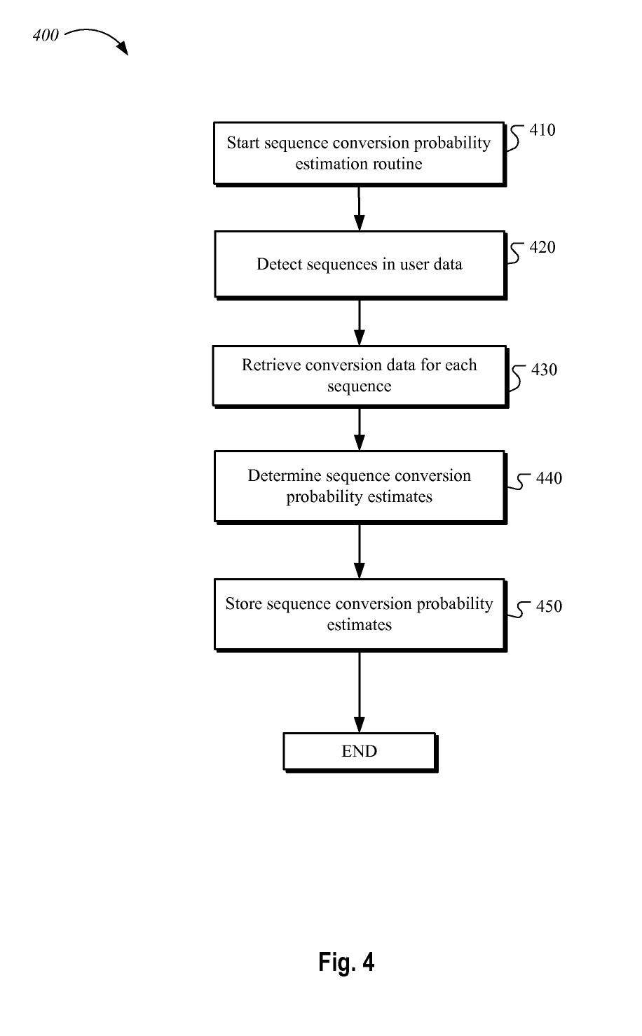

In some implementations, the estimate of the probability of conversion is retrieved 220 by accessing a record associated with the extended sequence. For example, the extended sequence may be identified by appending the candidate content item to the identified past sequence and mapping the augmented sequence to a sequence or group of sequences that the system analyzes. In some implementations, a parent node associated with the identified past sequence is accessed and a corresponding child node associated with the extended sequence is subsequently accessed (as described above) to retrieve 220 the estimate of the conditional probability of conversion. In some implementations, one or more eligible content items may be identified as candidate content items based on the existence of a corresponding child node in a tree structured set of sequence records. For example, estimates of the probabilities of conversion may be retrieved from all child nodes of the node corresponding to the identified past sequence and these estimates may be compared to select the next content item corresponding to the highest conditional probability of conversion. For example, process 400 of FIG. 4 may have been performed previously to determine estimates of probabilities of conversion for one or more sequences, including the extended sequence.

For example, the estimate of the conditional probability of conversion may be retrieved 220 from data store 119 by the content sequencing module 120 of the advertisement management system 110.

In some implementations, the estimate of the probability of conversion may be determined in real-time in response to the request for content.

A bid is determined 230 for the candidate content item based in part on the estimate of the conditional probability of conversion. In some implementations, the estimate of the conditional probability of conversion may be multiplied by a revenue estimate for conversions to determine 230 the bid. In some implementations, the bid is determined 230 to attempt to achieve a desired cost-per-conversion for the content item. For example, the bid may be determined 230 by multiplying the estimate of the conditional probability of conversion by the desired cost-per-conversion.

In some implementations, the bid may also be based on one or more factors reflecting the quality of the pairing of the impression with the candidate content item. Characteristics of the impression may be compared to desired characteristics for the candidate content item to assess the quality of the match. For example, keywords for the candidate content item may be compared to terms associated with the impression (e.g., terms occurring in a webpage that the content slot appears in or terms from a search query associated with the request for content) or demographic information (e.g., geographic location) about a user associated with the impression may be compared to desired demographic information for the candidate content item. One or more quality factors (e.g., a predicted click through rate) may be determined based on these comparisons and multiplied or otherwise combined (e.g., using a trained function approximator, such as a neural network) with the estimate of the conditional probability of conversion to determine 230 the bid.

For example, the bid may be determined 230 by the content sequencing module 120 of the advertisement management system 110.

The bid may be transmitted 232 to a server system that is auctioning an impression associated with the request for content. The server system running the auction may compare the bid to other bids it receives and a reserve price for the impression to select the winning bid. If the highest bid is above the reserve price, the highest bid is accepted. For example, the bid may be transmitted 232 through a network interface of the advertisement management system 110 to impression auction platform 130.

If the bid is accepted 235 (e.g., it is the winning bid), then the current impression is allocated to the content item. In this case, data specifying the selected content item may be transmitted 240 in response to the request for content. In some implementations, the data specifying the content item is a link that redirects a user device 106 to an advertiser device 108 that serves the content item. In some implementations, the selected content item can be provided to a user device that requested an online resource with which the content item is being provided. The content item may be provided to the user device 106, for example, over content delivery network 102. The content item may be provided with presentation instructions that specify a content slot in which the content item is to be presented. In turn, the content item can be presented on a user device 106 according to the presentation instructions. For example, data specifying the selected content item may be transmitted 240 through a network interface of the advertisement management system 110.

After the content item is presented in the impression, data may be received 242 reflecting a conversion result associated with the presentation of the content item and with the completion of an extended sequence including the identified sequence of past impressions for content items in the set of related content items and the content item just presented. In some implementations, the conversion result may be stored in a record associated with the extended sequence. For example, data reflecting the conversion result may be stored in data store 119. For example, data reflecting a conversion result may be received 242 through a network interface of the advertisement management system 110 from an advertiser 108 that has processed a purchase from the user associated with the extended sequence.

FIG. 2B is a flow chart of an example process 250 for selecting content items for presentation based in part on sequence information. Process 250 is similar to process 200, the main difference being an allocation score, rather than a bid, is determined based in the estimated conditional probability of conversion and an impression is allocated based on the allocation scores. For example, process 250 may be implemented when the advertisement management system is operating on behalf of a resource publisher of content to manage its impression inventory, while process 200 may be implemented when the advertising management system operates on behalf of an advertiser to buy impression inventory. The process 250 can be implemented, for example, by the content sequencing module 120 in the advertisement management system 110 of FIG. 1. In some implementations, the advertisement management system 110 is a data processing apparatus that includes one or more processors that are configured to perform actions of the process 250. For example, the data processing apparatus may be the apparatus 500 described in FIG. 5. In some implementations, a non-transitory computer readable storage medium can include instructions that when executed by a computing device (e.g., a computer system) cause the device to perform actions of the process 250.

According to process 250, a request for content is received 252, including a user identifier. For example, the user identifier may be included in a user authorized cookie that is associated with the request for content. With a user's permission, the user identifier may be used to access a browsing history for the associated user. For example, with a user's permission, a cookie may itself encode some of the corresponding user's browsing history. In some implementations, the user identifier points to and may be used to access a user session log or other data structure stored by a server system (e.g., advertisement management system 110 or another remote server) that encodes the user's browsing history. The request may also specify other parameters of a proposed impression (e.g., parameters of the content slot, terms from website or search terms from a query resulting in search results in which the content slot occurs). For example, the request may be received 252 through a network interface of the advertisement management system 110 from search system 112 or a website 104 that seeks to have a content item (e.g., an advertisement) presented to interested users in a current impression. In some implementations, the request may be received, along with a cookie, directly from a user device 106.

One or more sequences of related content items are identified 254 in the browsing history for the user. Step 254 may be essentially the same as step 210 of FIG. 2A. For example, the sequence may be identified 254 by the content sequencing module 120 of the advertisement management system 110.

An estimate of the conditional probability of conversion is retrieved 256 for an eligible content item in the set of related content items. Step 256 may be essentially the same as step 220 of FIG. 2A. For example, the estimate of the conditional probability of conversion may be retrieved 256 from data store 119 by the content sequencing module 120 of the advertisement management system 110.

An allocation score is determined 260 for the candidate content item based in part on the estimate of the conditional probability of conversion. For example, the allocation score may be determined by adding the estimate of the probability of conversion, weighted by a price per conversion for the candidate content item, to an intermediate allocation score. The intermediate score may be based on other factors such as price per impression for the candidate content item, a price per click for the candidate content item, user browsing history including resources related to the candidate content item, a match between keywords for the content item and terms for a search query or other terms associated with the content requested by the user, and/or a predicted click trough rate for the candidate content item in the impression. One or more factors (e.g., a predicted click through rate) may be multiplied or otherwise combined (e.g., using a trained function approximator, such as a neural network) with the estimate of the conditional probability of conversion to determine the bid intermediate score. For example, the allocation score may be determined 260 by the content sequencing module 120 of the advertisement management system 110.

If the content item has the best (e.g., highest) allocation score among all candidate content items 235, then the current impression is allocated to the content item. The content item is selected 270 for presentation to the user in response to the request for content. In this case, data specifying the selected content item may be transmitted 272 in response to the request for content. In some implementations, the data specifying the content item is a link that redirects a user device 106 to an advertiser device 108 that serves the content item. In some implementations, the selected content item can be provided to a user device that requested an online resource with which the content item is being provided. The content item may be provided to the user device 106, for example, over content delivery network 102. The content item may be provided with presentation instructions that specify a content slot in which the content item is to be presented. In turn, the content item can be presented on a user device 106 according to the presentation instructions. For example, data specifying the selected content item may be transmitted 272 through a network interface of the advertisement management system 110.

After the content item is presented in the impression, data may be received 274 reflecting a conversion result associated with the presentation of the content item and with the completion of an extended sequence including the identified sequence of past impressions for content items in the set of related content items and the content item just presented. In some implementations, the conversion result may be stored in a record associated with the extended sequence. For example, data reflecting the conversion result may be stored in data store 119. For example, data reflecting a conversion result may be received 274 through a network interface of the advertisement management system 110 from an advertiser 108 that has processed a purchase from the user associated with the extended sequence.

If the content item does not have the best (e.g., highest) allocation score among all candidate content items 235, then the current impression is allocated to a different candidate content item. A different candidate content item is selected 280 for presentation to the user in response to the request for content. Data specifying the selected content item may be transmitted 282 in response to the request for content. While conversion information may be received in some way in any case, the selected content item need not be part of an analyzed sequence. In the example depicted in FIG. 2A, the different content item is not a part of an analyzed sequence and thus conversion data is not received and stored for a sequence record.

FIG. 3 is a flow chart of an example process 300 for detecting sequences of content items in a browsing history for a user.

The process 300 can be implemented, for example, by the content sequencing module 120 in the advertisement management system 110 of FIG. 1. In some implementations, the advertisement management system 110 is a data processing apparatus that includes one or more processors that are configured to perform actions of the process 300. For example, the data processing apparatus may be the apparatus 500 described in FIG. 5. In some implementations, a non-transitory computer readable storage medium can include instructions that when executed by a computing device (e.g., a computer system) cause the device to perform actions of the process 300.

Process 300 may start 310 periodically to maintain a record associated with a user or upon the occurrence of an event. For example, the process may start 310 in response to a request for content, including a user identifier. In some implementations, the process 300 is started 310 periodically (e.g., hourly or daily) to update the sequence information for user that maintained in a stored record associated with the user. In some implementations, the process 300 is started 310 periodically (e.g., hourly, daily, or weekly) to extract sequence information from a user session log that may be used to update estimates of probabilities of conversion for sequences (e.g., as described in relation to FIG. 4).

Stored data for a user (e.g., a user session log) is retrieved 320. The user data may include a browsing history for the user. In some implementations, the user data includes time stamps for events (e.g., impressions or other user interactions) that are of interest. In some implementations, the user data encodes an explicit or implicit temporal ordering of events of interest. In some implementations, the stored data is read from memory or some other local data storage device. For example, the content sequencing module 120 may retrieve 320 stored user data from the data store 119. In some implementations, the stored user data may be retrieved 320 from a remote data storage device. For example, the stored user data may be received through a network interface of the advertising management system 110.

The user data is filtered 330 to extract events (e.g., impressions or other user interactions) related to content items in a set of related content items of interest. For example, the set of related content items may include content items of a particular advertiser, content items for a particular advertising campaign, or content items related to a particular product or service. In some implementations, the set of related content items of interest is limited to content items of particular media types (e.g., image, video, rich media, search advertisement, etc.). Examples of events that are extracted could include views, clicks, time spent watching a video content item, time spent on a landing page after clicking through a content item, or a number of pages viewed on a website after clicking through a content item, purchases, or other conversions, among other events. In some implementations, analysis of the user's browsing history is limited to a recent window of time (e.g., the last day, week, month, year, etc.).

For example, the user data may be filtered 330 by the content sequencing module 120 of the advertisement management system 110.

The raw sequence of extracted events of interest may be classified 340 as one or more sequences that are analyzed by the content sequencing module 120. In some implementations, multiple raw sequences may be classified as members of a group of sequences, where each sequence in the group is associated with the same one or more estimates of conditional probability of conversion for the group. Sequences can be grouped for analysis purposes in a variety of ways. For example, the raw sequence may be classified as a member of a group of sequences corresponding to permutations of the content items in the raw sequence.

In some implementations, sequences are classified as members of group of sequences by classifying a content item in the sequence of content items as a member of a subset of the set of content items of interest. For example, the set of content items may be advertisements of a particular advertiser and a subset may include advertisements in a particular advertising campaign. The advertiser may have three campaigns (A, B, C), each including two advertisements: {A1, A2, B1, B2, C1, C2}. A group of sequences for analysis may be specified as A->B->C, meaning any advertisement from campaign A followed by any advertisement from campaign B, followed by any advertisement from campaign C. Under this scheme, the sequences A1->B2->C1 and A2->B1->C2 both will be classified as members of the same group of eight sequences for sequence analysis purposes.

In some implementations, the each ordered sequence is analyzed individually, so the raw sequence is the sequence of interest.

In some implementations, ordered sequences are more finely classified for analysis purposes. For example, different instances of the same sequence of three content items (e.g., Ad1->Ad2->Ad3) may be classified into different analysis groups based on the time lags between impressions for the content items in the sequence. Where all three impressions occurred with 24 hours, the sequence may be in one analysis group, while sequences spread over a longer period may be in another analysis group. In some implementations, inter-impression time lags exceeding a threshold (e.g., a day or a week) cause the larger sequence to be ignored or bifurcated into shorter sequences before and after the gap. In some implementations, the time lags between impressions in the ordered sequences may be added as parameters of each recorded sequence for analysis purposes. Lag times may be quantized into sub-ranges or buckets for analysis purposes to prevent ordered sequences from becoming to sparse in the analysis data set. Thus, identifying 210 the sequence may include determining time intervals between content items in a detected sequence of content items.

Generally, there may be a trade-off between the specificity of the sequence classification scheme and sufficiency of the data available for estimation of probabilities of conversion for the sequences. For example, the sequence may be classified 340 by the content sequencing module 120 of the advertisement management system 110.

A sequence identifier for a classified sequence may be transmitted or stored 350 for future use in the selection of a content item for presentation to the user. In some cases, multiple sequence identifiers corresponding to multiple identified sequences may be stored 350 or transmitted. For example, the sequence identifier may be stored as part of record the user that may be referenced using a user identifier. For example, the sequence identifier may be written to a record for the user in the data store 119. In some implementations, the sequence identifier may be transmitted through a network interface of the advertisement management system 110, for example, to a user device 106 associated with the user. In some implementations, the sequence identifier may be stored in volatile memory for use in process such as process 400 for updating estimates of probabilities of conversion for sequences.

FIG. 4 is a flow chart of an example process 400 for estimating sequence conversion probabilities. The process 400 can be implemented, for example, by the content sequencing module 120 in the advertisement management system 110 of FIG. 1. In some implementations, the advertisement management system 110 is a data processing apparatus that includes one or more processors that are configured to perform actions of the process 400. For example, the data processing apparatus may be the apparatus 500 described in FIG. 5. In some implementations, a non-transitory computer readable storage medium can include instructions that when executed by a computing device (e.g., a computer system) cause the device to perform actions of the process 400.

Process 400 may start 410 periodically to maintain a record associated with sequences of interest or upon the occurrence of an event. For example, the process 300 may be started 310 periodically (e.g., hourly, daily, or weekly) to update estimates of probabilities of conversion for sequences that are stored as sequence records in data store 119. In some implementations, process 400 may start when upon manual initiation by an operator of advertisement management system 110.

Sequences may be detected 420 in user data for a large group of users (e.g., hundreds, thousands, or millions of users). For example process 300 of FIG. 3 may be employed to detect sequences of interest that occur in one of many user session logs stored in a data storage device (e.g., data store 119). The process 300 may be called for each of the user session logs that will be considered and sequence identifiers for these users may be returned. For example, sequences may be detected 420 by the content sequencing module 120 of the advertisement management system 110.

Conversion data may be retrieved 430 for each user with one or more detected sequences of interest. In some implementations, conversion data is retrieved from an advertiser associated with the set of content items of interest. For example, the advertiser may provide information about purchases made by users who have been exposed to a sequence. In some implementations, conversion data is stored in a user data record (e.g., a user session log). For example, a user session log may include data reflecting a user browsing a landing page for sufficient duration of time navigating to a sufficient depth at a website including the landing page for the last content item in the sequence. In some implementations, conversions are linked to a sequence by detecting temporal proximity of the conversion event to the presentation of the last content item in the sequence.

In some implementations, conversion data may be stored in records associated with the sequences that was collected by the content sequencing module 120 following presentation of the last content item in the sequence (e.g., as described in relation to step 242 of FIG. 2A).

For example, conversion data may be retrieved 430 by the content sequencing module 120 of the advertisement management system 110.

Estimates of the probabilities of conversion may be determined 440 for each analyzed sequence. In some implementations, an estimate for a sequence is determined by dividing a total count of conversions for the sequence by the total number of occurrences of the sequence across all users.

In some implementations, a minimum number (e.g., 10, 100, or 1000) of sequence occurrences is required before an estimated probability of conversion for the sequence will be considered robust enough for use in allocating impressions. If the minimum number of occurrences is not detected for a sequence, then a null value may be stored for the estimate of the conversion probability and the conditional probability of conversion can be ignored for the content item that completes the sequence when the parent sequence is detected in a user browsing history associated with a request for content. In some implementations, when there is insufficient data for a sequence, the sequence may be combined with a closely related sequence for analysis purposes. For example, lag time sub-ranges or buckets may be combined to consolidate smaller groups of sequences for analysis and thus combine their data sets. In some implementations, the use of time lags to classify sequences for analysis may be suspended altogether until the minimum data requirements are met for the desired analysis buckets.

For example, the estimates of the probabilities of conversion may be determined 440 by the content sequencing module 120 of the advertisement management system 110.

The estimates of the probabilities of conversion for the sequences may be stored 450. The estimates may be stored in records for each sequence that is analyzed by the content sequencing module 120. For example, the records for each sequence may be organized in one or more tree structures, where child nodes correspond to sequences matching the sequence(s) for the parent node with the one additional content item presented as the next content item in the sequence. For example, in the case of unique strictly ordered sequences (as opposed to, e.g., groups of permutations), the sequence for a parent node is a prefix for the sequence(s) corresponding to its child node(s). Given a sequence of past content item impressions, this structure may be accessed to find the node corresponding to past sequence and find estimates of conditional probabilities of conversion for possible next content items in the corresponding child nodes. For example, the estimates of the probabilities of conversion for the sequences may be stored 450 in data store 119 by content sequencing module 120 of advertisement management system 110.

FIG. 5 shows an example of a generic computer device 500 and a generic mobile computing device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a graphical user interface (GUI) on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a Thin-Film-Transistor Liquid Crystal Display (TFT LCD) or an Organic Light Emitting Diode (OLED) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a Single In Line Memory Module (SIMM) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or non-volatile random-access memory (NVRAM), as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as Global System for Mobile (GSM) voice calls, Short Message Service (SMS), Enhanced Messaging Service (EMS), or Multimedia Message Service (MMS) messaging, Code division multiple access (CDMA), Time Division Multiple Access (TDMA), Personal Digital Cellular (PDC), Wideband Code Division Multiple Access (WCDMA), CDMA2000, or General Packet Radio Service (GPRS), among others. Such communication may occur, for example, through radio-frequency transceiver 568. In addition, short-range communication may occur, such as using a Bluetooth, WiFi, or other such transceiver (not shown). In addition, Global Positioning System (GPS) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a cathode ray tube (CRT) or liquid crystal display (LCD) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method performed by one or more processing devices, the method comprising:
receiving a request for content and a user identifier;
identifying a sequence of content items in a browsing history corresponding to the user identifier, where the content items in the sequence are members of a set of content items;
retrieving an estimate of a conditional probability of conversion for a first content item from the set, where the first content item is presented after the identified sequence;
determining a bid for an impression in the requested content based in part on the estimate of the conditional probability of conversion; and
transmitting the bid.

2. The method of claim 1, further comprising:
transmitting data specifying the first content item in response to the request for content.

3. The method of claim 1, further comprising:
receiving data reflecting a conversion resulting from presentation of the first content item; and
storing data reflecting the conversion in a record associated with a sequence consisting of the identified sequence followed by the first content item.

4. The method of claim 1, in which identifying the sequence of content items comprises:
determining time intervals between content items in a detected sequence of content items.

5. The method of claim 1, in which identifying the sequence of content items comprises:
classifying a content item in the sequence of content items as a member of a subset of the set of content items.

6. The method of claim 5, in which the set of content items are advertisements of an advertiser and the subset includes advertisements in a particular advertising campaign.

7. The method of claim 1, in which identifying the sequence of content items comprises:
classifying the sequence of content items as a member of a set of sequences that are each associated with the same one or more estimates of conditional probability of conversion.

8. The method of claim 7, in which the set of sequences includes permutations of the content items in the sequence.

9. The method of claim 1, in which the estimate of the conditional probability of conversion is an estimate of the probability that a user will make a purchase associated with the first content item being present after the identified sequence.

10. A method performed by one or more processing devices, the method comprising:
receiving a request for content and a user identifier;
identifying a sequence of content items in a browsing history corresponding to the user identifier, where the content items in the sequence are members of a set of content items;
retrieving an estimate of a conditional probability of conversion for a first content item from the set, where the first content item is presented after the identified sequence;
determining an allocation score for the first content item based in part on the estimate of the conditional probability of conversion;
selecting the first content item for presentation to user based on the allocation score; and
transmitting data specifying the first content item in response to the request for content.

11. The method of claim 10, in which identifying the sequence of content items comprises:
determining time intervals between content items in a detected sequence of content items.

12. The method of claim 10, in which identifying the sequence of content items comprises:
classifying a content item in the sequence of content items as a member of a subset of the set of content items.

13. The method of claim 12, in which the set of content items are advertisements of an advertiser and the subset includes advertisements in a particular advertising campaign.

14. The method of claim 10, in which identifying the sequence of content items comprises:
classifying the sequence of content items as a member of a set of sequences that are each associated with the same one or more estimates of conditional probability of conversion.

15. The method of claim 14, in which the set of sequences includes permutations of the content items in the sequence.

16. The method of claim 10, in which the estimate of the conditional probability of conversion is an estimate of the probability that a user will make a purchase associated with the first content item being present after the identified sequence.

17. A system, comprising:
one or more data processing apparatus; and
a memory coupled to the one or more data processing apparatus having instructions stored thereon which, when executed by the one or more data processing apparatus cause the one or more data processing apparatus to perform operations comprising:
receiving a request for content and a user identifier;
identifying a sequence of content items in a browsing history corresponding to the user identifier, where the content items in the sequence are members of a set of content items;
retrieving an estimate of a conditional probability of conversion for a first content item from the set, where the first content item is presented after the identified sequence;
determining a bid for an impression in the requested content based in part on the estimate of the conditional probability of conversion; and
transmitting the bid.

18. The system of claim 17, in which the operations further comprise:
transmitting data specifying the first content item in response to the request for content.

19. The system of claim 17, in which the operations further comprise:
receiving data reflecting a conversion resulting from presentation of the first content item; and
storing data reflecting the conversion in a record associated with a sequence consisting of the identified sequence followed by the first content item.

20. The system of claim 17, in which identifying the sequence of content items comprises:
determining time intervals between content items in a detected sequence of content items.

21. The system of claim 17, in which identifying the sequence of content items comprises:
classifying a content item in the sequence of content items as a member of a subset of the set of content items.

22. The system of claim 21, in which the set of content items are advertisements of an advertiser and the subset includes advertisements in a particular advertising campaign.

23. The system of claim 17, in which identifying the sequence of content items comprises:
classifying the sequence of content items as a member of a set of sequences that are each associated with the same one or more estimates of conditional probability of conversion.

24. The system of claim 23, in which the set of sequences includes permutations of the content items in the sequence.

25. The system of claim 17, in which the estimate of the conditional probability of conversion is an estimate of the probability that a user will make a purchase associated with the first content item being present after the identified sequence.

26. A system, comprising:
one or more data processing apparatus; and
a memory coupled to the one or more data processing apparatus having instructions stored thereon which, when executed by the one or more data processing apparatus cause the one or more data processing apparatus to perform operations comprising:
receiving a request for content and a user identifier;
identifying a sequence of content items in a browsing history corresponding to the user identifier, where the content items in the sequence are members of a set of content items;
retrieving an estimate of a conditional probability of conversion for a first content item from the set, where the first content item is presented after the identified sequence;
determining an allocation score for the first content item based in part on the estimate of the conditional probability of conversion;
selecting the first content item for presentation to user based on the allocation score; and
transmitting data specifying the first content item in response to the request for content.

27. The system of claim 26, in which identifying the sequence of content items comprises:
determining time intervals between content items in a detected sequence of content items.

28. The system of claim 26, in which identifying the sequence of content items comprises:
classifying a content item in the sequence of content items as a member of a subset of the set of content items.

29. The system of claim 28, in which the set of content items are advertisements of an advertiser and the subset includes advertisements in a particular advertising campaign.

30. The system of claim 26, in which identifying the sequence of content items comprises:
classifying the sequence of content items as a member of a set of sequences that are each associated with the same one or more estimates of conditional probability of conversion.

31. The system of claim 30, in which the set of sequences includes permutations of the content items in the sequence.

32. The system of claim 26, in which the estimate of the conditional probability of conversion is an estimate of the probability that a user will make a purchase associated with the first content item being present after the identified sequence.

33. A system, comprising:
a network interface configured to receive a request for content and a user identifier;
a means for identifying a sequence of content items in a browsing history corresponding to the user identifier, where the content items in the sequence are members of a set of content items;
a module configured to retrieve an estimate of a conditional probability of conversion for a first content item from the set, where the first content item is presented after the identified sequence;
a module configured to determine a bid for an impression in the requested content based in part on the estimate of the conditional probability of conversion; and
a network interface configured to transmit the bid.

34. The method of claim 33, further comprising:
receiving data reflecting a conversion resulting from presentation of the first content item; and
storing data reflecting the conversion in a record associated with a sequence consisting of the identified sequence followed by the first content item.

35. The method of claim 33, in which the estimate of the conditional probability of conversion is an estimate of the probability that a user will make a purchase associated with the first content item being present after the identified sequence.
